(19) United States
(12) Patent Application Publication
(10) Pub. No.: US 2007/0084416 A1
(43) Pub. Date: Apr. 19, 2007

(54) Pet grooming comb capable of adjusting holding angle easily

(75) Inventor: Yi-Tang Liao, Taichung County (TW)

Correspondence Address: BACON & THOMAS, PLLC, 625 SLATERS LANE, FOURTH FLOOR, ALEXANDRIA, VA, 22314, US

(73) Assignee: JENG SHYUAN PRECISION CO., LTD., TAICHUNG COUNTY (TW)

(21) Appl. No.: 11/249,483

(22) Filed: Oct. 14, 2005

(51) Int. Cl. A01K 13/00

(52) U.S. Cl. 119/625

(57) ABSTRACT

A pet grooming comb whose holding angle can be adjusted conveniently includes a handle having a handle body and an angle positioning member, a comb head pivoted to the handle and provided with a comb head body, an angle positioning member multi-angleably coupled to the angle positioning member of the handle, and a toothed blade, and a release control unit having an elastic member for driving the angle positioning member of the handle to urge and lock the angle positioning member of the comb head, and a hand control member for driving the angle positioning member of the handle to detach from the angle positioning member of the comb head so that the handle is pivotable relative to the comb head.

### BACKGROUND OF THE INVENTION

1. Field of the Invention

The present invention relates to a pet grooming comb and more particularly to such a pet grooming comb whose holding angle can be adjusted conveniently.

2. Description of the Related Art

A conventional pet grooming comb comprises a handle and a comb head fixed to the handle. However, the comb head is fixed to the handle, so that the relative angle between the handle and the comb head cannot be adjusted according to the user's need.

In order to resolve the above-mentioned problem another conventional pet grooming comb which can adjust the relative angle between the comb head and the handle is developed. This conventional pet grooming comb comprises a handle and a comb head detachably mounted to the handle. However, a user has to drive an operation device by his one hand to release the comb head and to detach the comb head from the handle by his other hand so that the comb head can be rotated relative to the handle and then be reinstalled in the handle, thereby causing inconvenience to the user.

### SUMMARY OF THE INVENTION

The primary objective of the present invention is to provide a pet grooming comb whose holding angle can be adjusted conveniently, wherein the relative angle between the handle and the comb head is adjusted conveniently, thereby facilitating a user to adjust the angle freely.

Another objective of the present invention is to provide a pet grooming comb whose holding angle can be adjusted conveniently, wherein the adjustment mechanism for adjusting the relative angle between the handle and the comb head is simple in structural, convenient in operation, easy in adjustment, and exact in positioning function.

The present invention has been accomplished under the circumstances in view. To achieve the above-mentioned objective, the pet grooming comb provided by the present invention comprises a handle having a handle body and an angle positioning member, a comb head pivoted to the handle and provided with a comb head body, an angle positioning member multi-angleably coupled to the angle positioning member of the handle, and a toothed blade, and a release control unit having an elastic member for driving the angle positioning member of the handle to urge and lock the angle positioning member of the comb head, and a hand control member for driving the angle positioning member of the handle to detach from the angle positioning member of the comb head so that the handle is pivotable relative to the comb head.

### BRIEF DESCRIPTION OF THE DRAWINGS

FIG. 1 is a perspective view according to a preferred embodiment of the present invention.

FIG. 2 is an exploded perspective view according to a preferred embodiment of the present invention.

FIG. 3 is a top plan locally cross-sectional view according to a preferred embodiment of the present invention.

FIG. 4 is a schematic locally operational view of FIG. 3.

FIG. 5 is a usage state view according to a preferred embodiment of the present invention.

FIG. 6 is another usage state view according to a preferred embodiment of the present invention.

FIG. 7 is an exploded perspective view according to another preferred embodiment of the present invention.

FIG. 8 is a top plan cross-sectional view according to still another preferred embodiment of the present invention.

FIG. 9 is a top plan cross-sectional view according to still another preferred embodiment of the present invention.

### DETAILED DESCRIPTION OF THE INVENTION

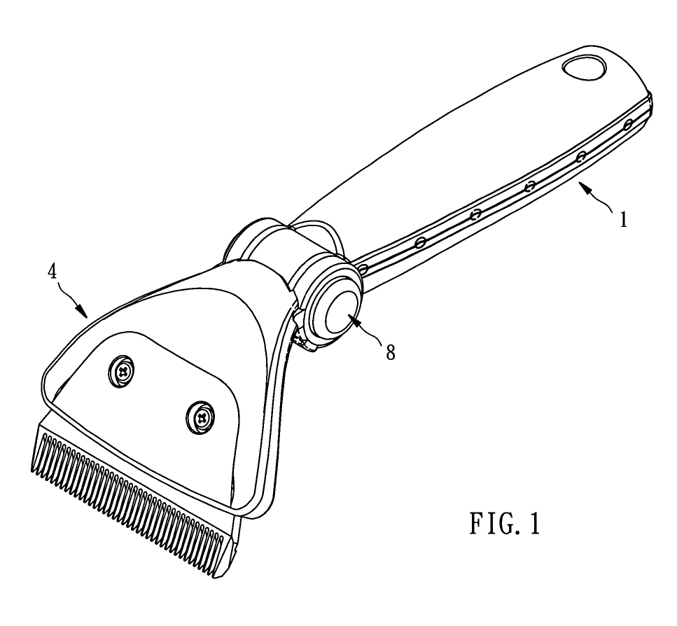

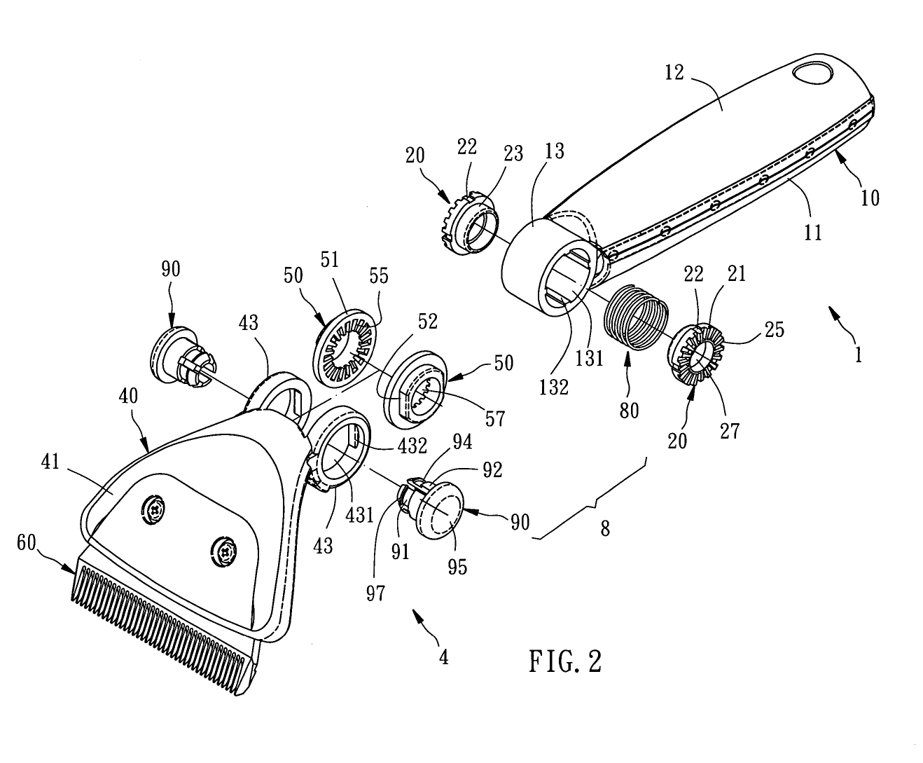

Referring to FIGS. 1-3, a pet grooming comb in accordance with a preferred embodiment of the present invention comprises the following elements.

A handle 1 has a handle body 10 assembled by a first shell 11 and a second shell 12, a pivot portion 13 integrally connected to the first shell 11 and provided with a pivot hole 131 and several anti-rotation portions 132 having a rib shape. Two angle positioning members 20 each have a wheel 21 having four anti-rotation portions 22 having a recessed shape and being movably mounted in the pivot hole 131 and the anti-rotation portions 132 of the handle body 10 of the handle 1, a resting portion 23, a positioning portion 25 having a toothed disk shape and mounted on the other face of the resting portion 23, and a pivot hole 27.

A comb head 4 has a comb head body 40 having a mounting portion 41 and two pivot portions 43 each having a pivot hole 431 and two anti-rotation portions 432. Two angle positioning members 50 each have a wheel 51, an anti-rotation portion 52, a positioning portion 55 having a toothed disk shape and locked with the positioning portion 25 of the angle positioning member 20 of the handle 1, and a pivot hole 57. A toothed blade 60 is slidably mounted on the mounting portion 41 of the comb head body 40.

A release control unit 8 has a spring like elastic member 80 mounted in the pivot hole 131 of the handle 1 and stopped with two ends thereof at the resting portions 23 of the two angle positioning members 20 respectively. Two hand control members 90 each have a first pivot tube 91 extended through the pivot hole 27 of each of the angle positioning members 20 of the handle 1, a second pivot tube 92 extended through the pivot hole 57 of each of the angle positioning members 50 of the comb head 4, a resting portion 94 rested on a predetermined portion of the angle positioning member 20 of the handle 1, a press portion 95 operated by a user's hand, and a stop portion 97 coupled to the angle positioning member 20.

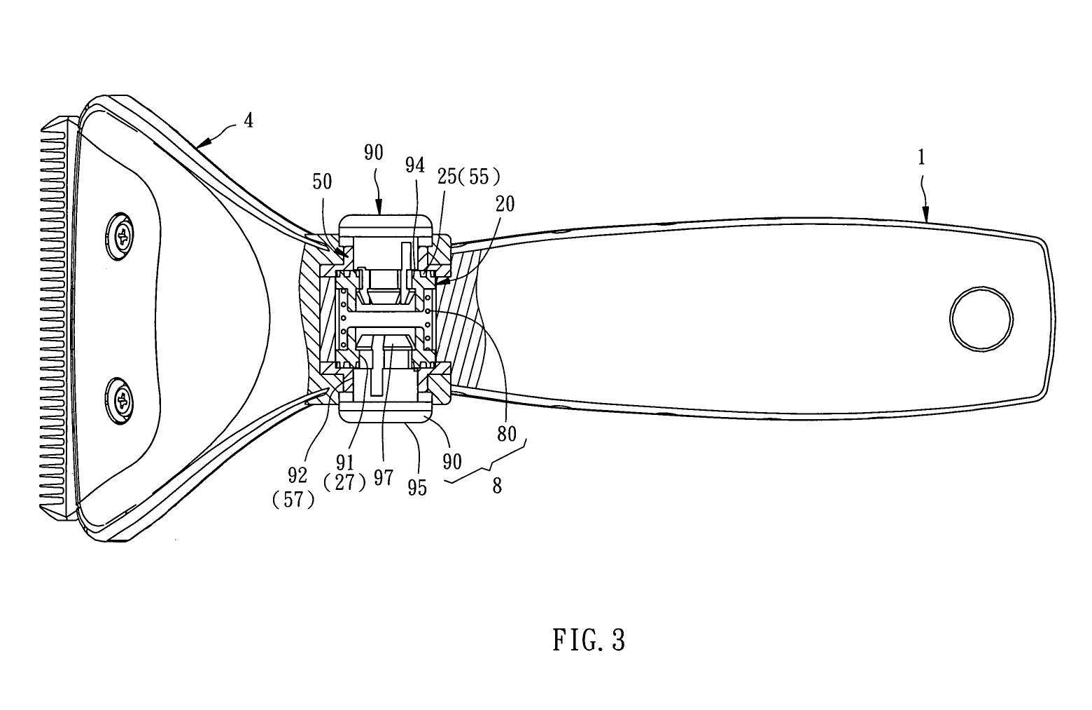

As shown in FIG. 3, when the pet grooming comb is in a fixed state, the handle 1 cannot rotate relative to the comb head 4. Each of the angle positioning members 20 is pushed outward by the elastic member 80 so that the positioning portion 25 is locked on the positioning portion 55 of the angle positioning member 50, and the first pivot tube 91 and second pivot tube 92 of each of the two hand control members 90 are pivoted on the respective angle positioning members 20 and 50.

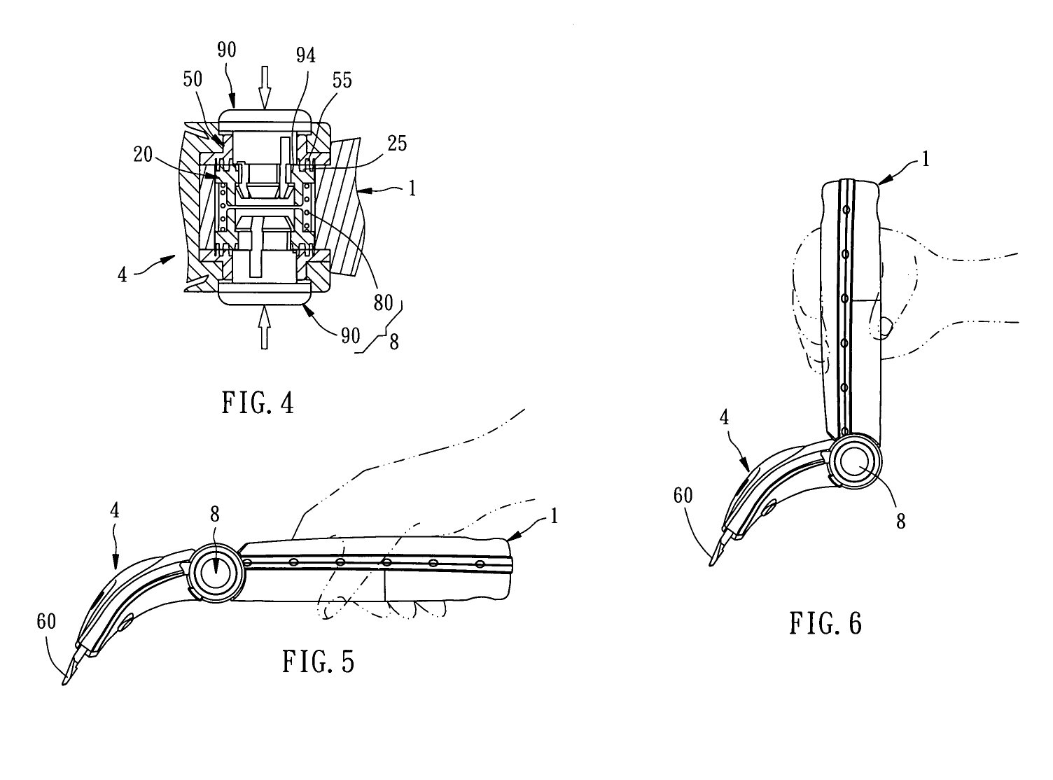

As shown in FIG. 4, the press portions 95 of the two hand control members 90 are pressed by the user's two fingers, so that the resting portion 94 of each of the two hand control members 90 pushes each of the angle positioning members 20 to axially move inward in parallel to detach the positioning portion 25 of each of the angle positioning members 20 from the positioning portion 55 of the angle positioning member 50. At this time, the handle 1 is rotatable relative to the comb head 4 for adjusting the relative angle between the handle 1 and the comb head 4, and the handle 1 can be fixed after the two hand control members 90 are released.

As shown in FIG. 5, the pet grooming comb has a linear angled state. As shown in FIG. 6, the handle 1 rotates relative to the comb head 4 to be perpendicular to the comb head 4 to facilitate holding of the user.

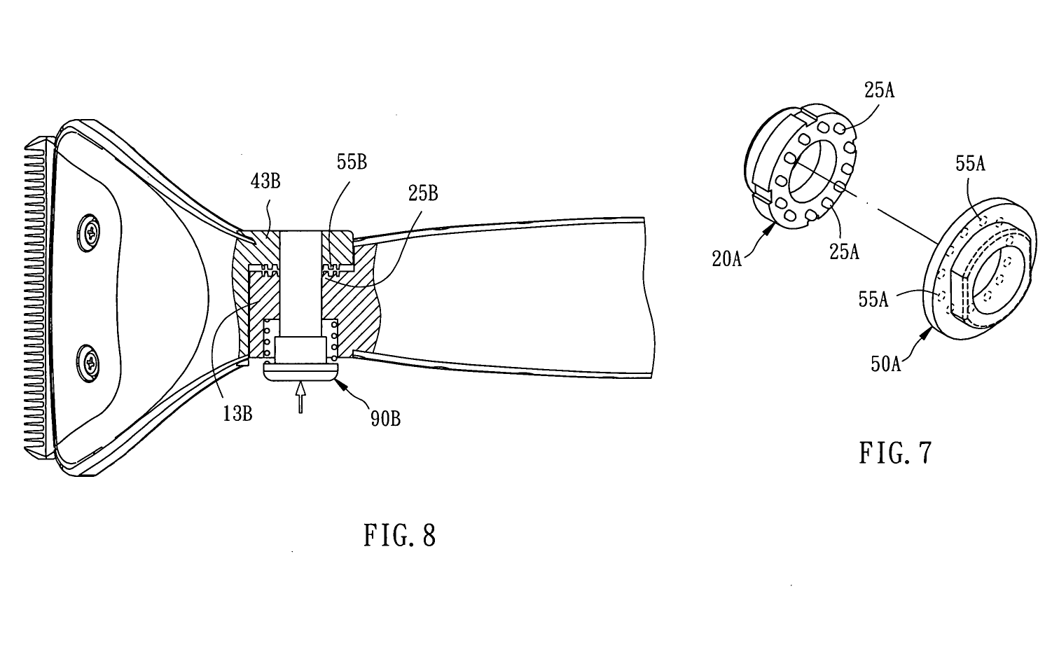

As shown in FIG. 7, in accordance with another preferred embodiment of the present invention, the positioning portion 25A of the angle positioning member 20A of the handle has several posts, and the positioning portion 55A of the angle positioning member 50A of the comb head has several insertion holes for insertion of the positioning portion 25A of the angle positioning member 20A. Similarly, the positioning portion of the angle positioning member of the handle and the positioning portion of the angle positioning member of the comb head can be crown shaped teeth, spline shaft teeth, protruding points, columns, dimples, or holes having the same function.

As shown in FIG. 8, in accordance with another preferred embodiment of the present invention, the positioning portion 25B of the angle positioning member of the handle is integrally formed on the pivot portion 13B of the handle, the positioning portion 55B of the angle positioning member of the comb head is also integrally formed on the pivot portion 43B of the comb head, and the hand control member 90B of the release control unit is connected to the pivot portion 43B of the comb head to simplify the construction of the pet grooming comb. Of course, the hand control member of the release control unit can be integrally connected to the angle positioning member of the handle.

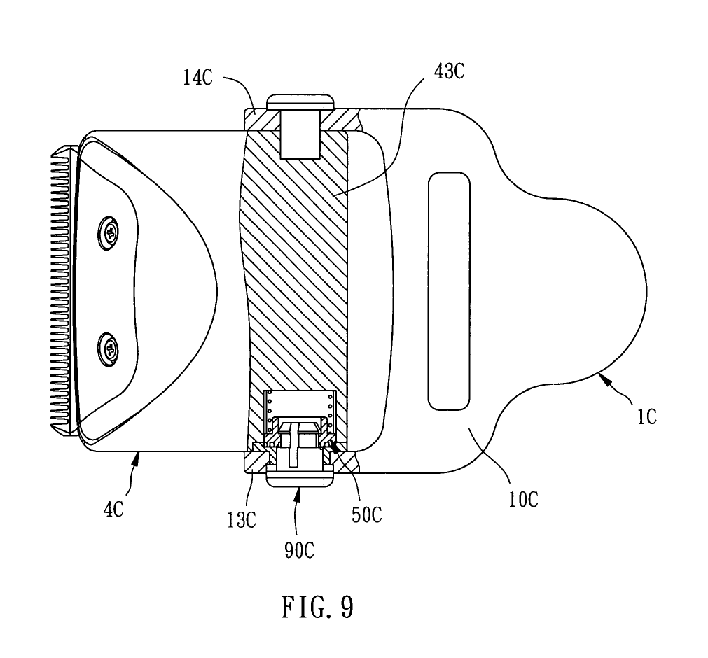

As shown in FIG. 9, in accordance with still another preferred embodiment of the present invention, the handle 1C has a handle body 10C having a wide holding shape and having two sides each having a pivot portion 13C and 14C. The comb head 4C has a pivot portion 43C pivoted to the pivot portions 13C and 14C of the handle 1C, and an angle positioning member 50C. The release control unit only has a hand control member 90C mounted on a side of the pivot portion 13C of the handle 1C to be pressed to push the angle positioning members 50C of the comb head 4C to move axially.

Although particular embodiments of the invention have been described in detail for purposes of illustration, various modifications and enhancements may be made without departing from the spirit and scope of the invention. For example, the toothed blade of the comb head can be designed to be integrally connected to the comb head body. In addition, the angle positioning member of the comb head can be designed to be pivoted to the pivot portion of the handle; alternatively, the angle positioning member of the handle can be designed to be pivoted to the pivot portion of the comb head; otherwise, the angle positioning member of the comb head can be designed to be pivoted to the angle positioning member of the handle. These alternative designs can also achieve the purpose and effect of the present invention.

1. Accordingly, the relative angle between the handle and the comb head is adjusted conveniently, thereby facilitating a user to adjust the angle freely.

2. In addition, the adjustment mechanism for adjusting the relative angle between the handle and the comb head is simple in structural, convenient in operation, easy in adjustment, and exact in positioning function.

1. A pet grooming comb comprising:
A handle having a handle body and an angle positioning member, said handle body having a pivot portion having a pivot hole therethrough, said handle body further having an anti-rotation portion mounted in said pivot hole, said angle positioning member being axially movably mounted inside said pivot hole of the handle body, and said angle positioning member having an anti-rotation portion axially movably mounted on said anti-rotation potion of the handle body;
a comb head pivoted to said handle, said comb head having a comb head body, an angle positioning member multi-angleably coupled to said angle positioning member of said handle, and a toothed blade, such that said angle positioning member of said handle permits pivoting of said handle relative to said comb head; and
a release control unit having an elastic member for driving said angle positioning member of said handle to urge and lock said angle positioning member of said comb head, and a hand control member for driving said angle positioning member of said handle to detach from said angle positioning member of said comb head so that said handle is pivotable relative to said comb head.

2. The pet grooming comb as claimed in claim 1, wherein said handle and said comb are pivoted with each other directly.

3. The pet grooming comb as claimed in claim 1, wherein said handle is pivoted to said comb head by said release control unit.

4. (canceled)

5. The pet grooming comb as claimed in claim 1, wherein said angle positioning member of said comb head is axially movable relative to said comb head body in a direction parallel with a pivot axis of said handle that is pivoted to said comb head.

6. The pet grooming comb as claimed in claim 1, wherein said angle positioning member of said handle has crown shaped teeth, spline shaft teeth, protruding points, columns, dimples or holes.

7. The pet grooming comb as claimed in claim 1, wherein said angle positioning member of said comb head has crown shaped teeth, spline shaft teeth, protruding points, columns, dimples or holes.

8. (canceled)

9. (canceled)

10. The pet grooming comb as claimed in claim 1, wherein said comb head further has a mounting potion on which said toothed blade is mounted.
